(19) United States
(12) Patent Application Publication
(10) Pub. No.: US 2014/0164379 A1
(43) Pub. Date: Jun. 12, 2014

(54) Automatic Attribute Level Detection Methods

(71) Applicant: Perceptive Software Research and Development B.V., Apeldoorn (NL)

(72) Inventors: Gueorgui Ivanov Jojgov, Eindhoven (NL); Petrus Cornelis Wilhelmus van den Brand, 's-Hertogenbosch (NL)

(73) Assignee: Perceptive Software Research and Development B.V., Apeldoorn (NL)

(21) Appl. No.: 13/894,811

(22) Filed: May 15, 2013

Related U.S. Application Data
(60) Provisional application No. 61/647,431, filed on May 15, 2012.

(51) Int. Cl. G06F 17/30

(52) U.S. Cl. CPC G06F 17/30598
USPC 707/737

(57) ABSTRACT

A method of detecting attribute levels in a dataset that includes determining whether column data in a column for a case identifier is the same, classifying the column data as case level attributes if all of the column data is identical, and classifying the column data as event level attributes if the column data is different for at least one data entry in the column.

### CROSS REFERENCES TO RELATED APPLICATIONS

The present application is related to and claims priority under 35 U.S.C. 119(e) from U.S. provisional application No. 61/647,431, filed May 15, 2012, entitled, “Automatic Attribute Level Detection Method,” the content of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The present disclosure relates generally to automatically distinguishing between case and event data attributes in an event log of a process.

2. Description of the Related Art

Event log data records detail the execution history of a process and are usually extracted or collected from one or more systems that support a given process. These details may relate to different levels of abstraction. For example, the name of a person that executes a given process step or action is related to the event describing the completion of that step or action, but the name of a person who initiates a new instance of the process does not change as the process is being executed and therefore relates to the instance as a whole. This type of structured information is often referred to as an attribute, and every attribute may be described by identifying information, such as an identifier or name, a type of data the attribute holds, and the level of abstraction to which the attribute belongs. Event log data is often supplied as one large matrix or table, where the rows of the table represent individual events and the columns are attributes.

Determining whether a column contains case or event level attributes may be useful as a basis for or in the course of importing data, such as in process or social network modeling, in order to make intelligent suggestions to a user. Determining the attribute level for each of the attributes in a case helps make data aggregation easier and more efficient and enables the user to more easily understand, and subsequently, analyze given data. Determining the levels of each of the attributes for a case may also provide useful information for other applications that seek faster and more effective methods of process discovery and visualization.

Over time, and as businesses become more complex, organizing and analyzing large amounts of input data that have accumulated over a time period may become a long and arduous task. Known solutions for analyzing and classifying input data include manually determining the levels of each attribute, which may be a laborious chore and require a lot of time, energy and other resources. Other known methods of organizing and analyzing data assume that every attribute of a case in a process has the same attribute level, which does not help improve analysis or organization of the data or the speed with which they may be accomplished.

Thus, what is needed is a method for automatically detecting the levels of one or more attributes in a process.

### SUMMARY

A system capable of and methods for automatically determining whether information associated with a case in a process is an event level or a case level attribute are disclosed herein.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is an example dataset for an example appeal process.

FIG. 2 is an example dataset for an example purchasing process.

FIG. 3 shows one example embodiment of a method for automatic attribute level detection.

FIG. 4 is an example interface displaying information resulting from the performance of the example method of FIG. 3.

### DETAILED DESCRIPTION

It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top”, “bottom”, “front”, “back”, “rear” and “side” “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

In addition, it should be understood that embodiments of the present disclosure may include both hardware and electronic components or modules that, for purposes of discussion, may be illustrated and described as if the majority of the components were implemented solely in software.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable storage medium that may direct a computer or other programmable data processing apparatus to function in a particular manner, such that the instructions stored in the computer-readable storage medium may produce an article of manufacture including an instruction means that implements the function specified in the block or blocks. Computer readable storage medium includes, for example, disks, CD-ROMS, Flash ROMS, nonvolatile ROM and RAM. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks. Output of the computer program instructions, such as the classification of case attributes, as will be described in greater detail below, may be displayed in a user interface or computer display of the computer or other programmable apparatus that implements the functions or the computer program instructions.

Blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

A process or workflow may be viewed as a sequence of events, activities, steps or interactions that are performed to achieve a stated purpose or goal. An event, activity, step or interaction may itself be a subprocess having its own sequence of events, activities, steps or interactions. A process that is executed in a given system may record raw data corresponding to such events, activities, steps or interactions in an event or data log or dataset.

Data logs may be in the form of a matrix or table. In some example embodiments, rows in data logs represent events, activities, steps or interactions in a process, and the columns represent attributes corresponding to such events, activities, steps or interactions. In alternate example embodiments, rows in data logs represent attributes corresponding to events, activities, steps or interactions of a process, and the columns represent such events, activities, steps or interactions.

In some example embodiments, where rows represent events, activities, steps or interactions in a process, a case is represented in a data log as a collection of rows sharing the same case identifier.

Each event, activity, step or interaction in the data log includes a case identifier and may include attributes or pieces of information corresponding to such case. A data log may require attributes to be recorded in a specific format or allow free form text. One example format recording a date is MM/DD/YYYY, where MM is the two-digit representation of the month. DD is the two-digit representation of the day of the month and YYYY is the four-digit representation of the year.

A case identifier refers to a record indicator or unique identifier, such as a number, that identifies which activities, events, steps or interactions are associated with a particular process instance or case. For example, a case identifier may uniquely identify the object, subject, or item going through a state. The process instance or case may consist of a number of activities, events, steps or interactions. One activity, event, step or interaction may specify a state of the process instance at a given moment in time. Therefore, each activity, event, step or interaction specifies at least the case identifier of the process instance associated with it, a time the event occurred and a state of the process instance at that time.

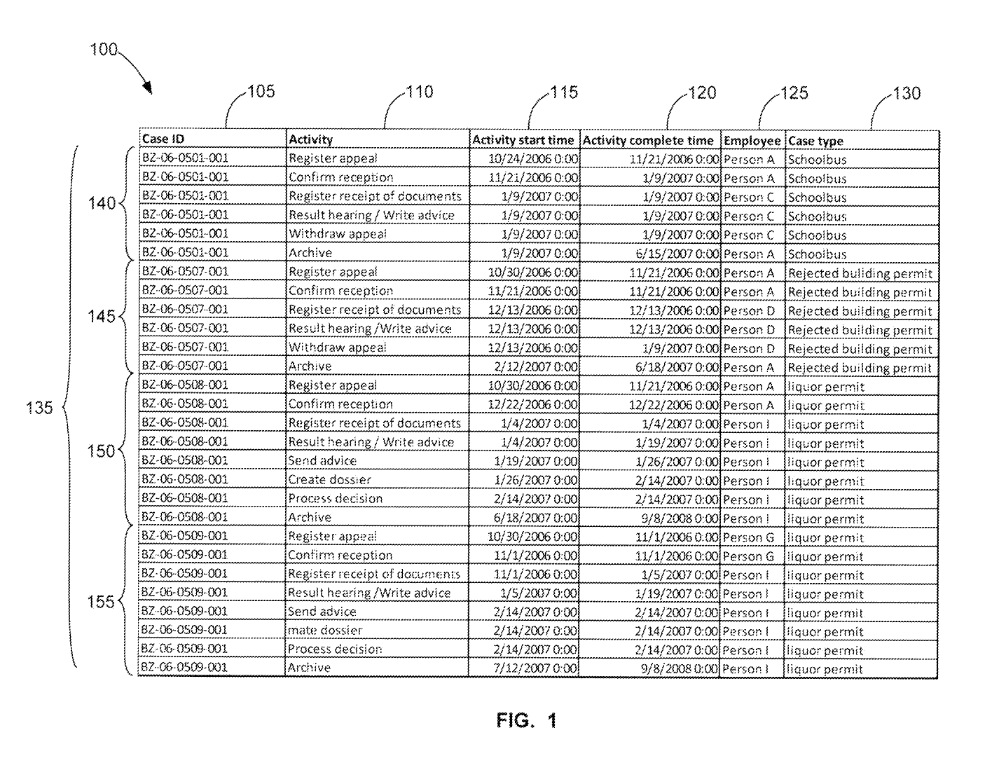

FIG. 1 illustrates one example data log 100 associated with an example appeal process for obtaining government permits. Data log 100 is merely utilized to illustrate attribute level detection in a data log in one example embodiment and should not be considered limiting. Attribute level detection in data log 100 is therefore not limited to an appeal process, and attribute level detection may be used in conjunction with any workflow or process used in any business or industry.

As shown in FIG. 1, example data log 100 includes columns labeled Case ID 105, Activity 110, Activity Start Time 115, Activity Complete Time 120, Employee 125 and Case Type 130. These columns correspond to a process instance and attributes of a particular event or activity in the example appeals process. The description recorded in column Case Type 130 represents an identifier of the type of case being appealed. Each of rows 135 in data log 100 corresponds to a recording or memorialization of the occurrence of a particular event or activity in the example appeal process.

The attribute recorded in column Activity 110 specifies the state or event or activity of the process instance or case which commenced at the associated timestamp attribute recorded in column Activity Start Time 115. The timestamp attribute recorded in column Activity Complete Time 120 indicates the time that the corresponding event, described in column Activity 110, ended. While the timestamps recorded in columns Activity Start Time 115 and Activity Complete Time 120 record both the date and time, only the date or the time may be recorded in some aspects. In the same or other aspects, the timestamps may be recorded in other formats. Separate process instances or distinct cases are represented in FIG. 1 as event groups 140, 145, 150 and 155.

The name recorded in column Employee 125 represents an identifier of the actor performing the corresponding event recorded in column Activity 110. An actor may be a player or a performer in the process such as, for example, a user, a client, or other personnel that are involved in different activities in the process. For example, an actor may represent a user that accesses, performs and/or manages the event or activity described in column Activity 110. In some example aspects, an actor may be a role, a business unit, a department, a team, an area or another group sharing a common function, attribute or goal.

It will be appreciated by those skilled in the art that in some example embodiments, some of the columns may be omitted and/or other columns containing process data may replace the existing columns and/or be added to data log 100.

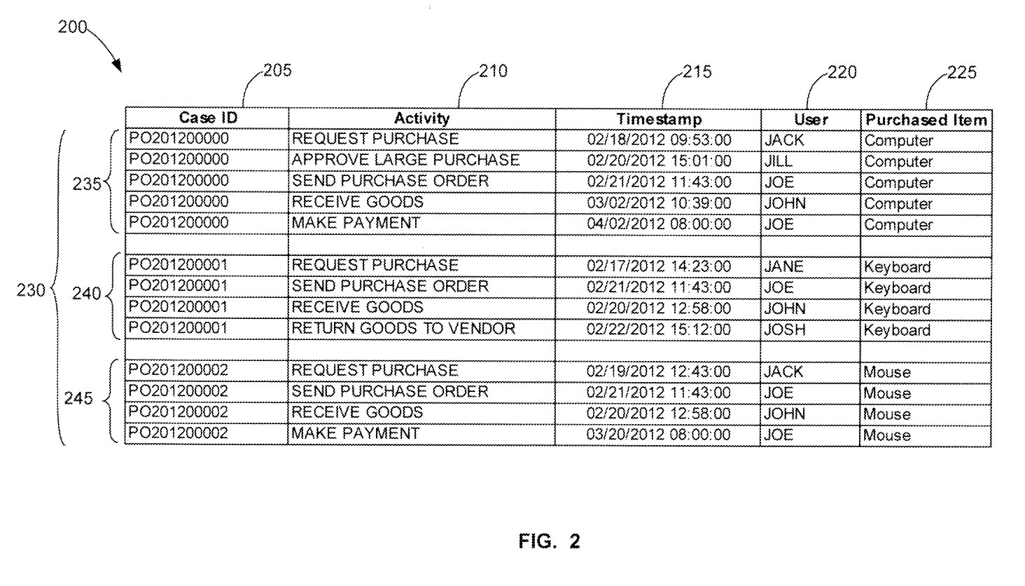

FIG. 2 illustrates a second example data log 200 associated with an example purchasing process. Data log 200 includes columns Case ID 205, Activity 210, Timestamp 215, User 220 and Purchased Item 225. Similar to data 100, each of the rows 230 in data log 200 corresponds to a particular event or activity that occurred in the purchasing process. The time attribute as detailed in Timestamp 215 indicates the time that the event or activity occurred and the attribute described in column Activity 210 specifies the state of the case or process instance at the corresponding timestamp, reflected in column Timestamp 215. While the timestamp recorded in column Timestamp 215 shows both the date and time, only the date or the time may be recorded in some aspects. In the same or other aspects, the timestamp may be recorded in other formats. In example data log 200, the separate process instances or cases are shown as event groups 235, 240 and 245.

In some example embodiments, some of the columns may be omitted and/or other columns containing process data may replace the existing columns and/or be added to data log 200. For example, purchasing process data log 200 may contain a column for recording purchase order cost information in some example embodiments.

The name recorded in column User 220 represents an identifier of the actor performing the corresponding event recorded in column Activity 210. An actor may be a player or a performer in the process such as, for example, a user, a client, or other personnel that are involved in different activities in the process. For example, an actor may represent a user that accesses, performs and/or manages the event or activity described in column Activity 210. In some example aspects, an actor may be a role, a business unit, a department, a team, an area or another group sharing a common function, attribute or goal.

In some example embodiments, rows 135 and 230 in example data logs 100 and 200, respectively, may be sorted or grouped according to at least one of the columns in data logs 100 and 200. For illustrative purposes, rows 135 and 230 in data logs 100 and 200 are sorted according to case identifiers 105 and 205, respectively. In some alternative example embodiments, rows 135 and 230 may be sorted using other data values or criteria, as is known by those skilled in the art.

The sorted data may be used for automatic attribute detection, as will be described in greater detail below.

In some example embodiments, the sorted data may be stored on a non-transitory computer readable storage medium for use by an application for automatically detecting levels of events from a set of data, such as example data logs 100 and 200. In other example embodiments, the data may be stored on a non-transitory computer readable storage medium as originally recorded in data logs 100 or 200, and the sorting of the data may be performed by the application prior to the detection of the levels of events from data logs 100 or 200.

While the example embodiments of FIGS. 1 and 2 illustrate sorted data in rows 135 and 230, the sorting of the data is not a requirement for automatically distinguishing between case and event level attributes. It is not necessary for the data to be pre-sorted in any manner to perform the example methods of the present disclosure.

Attributes may be either a case level attribute or an event level attribute. Case level attributes are attributes that are global or apply to all events in a process instance or case for the duration of the processing. In one alternative example embodiment, a case level attribute may be an immutable attribute associated with an event. An event level attribute is an attribute that is associated with a specific activity, event, step or interaction. The value of an event level attribute may change from one activity, event, step or interaction to another in the process.

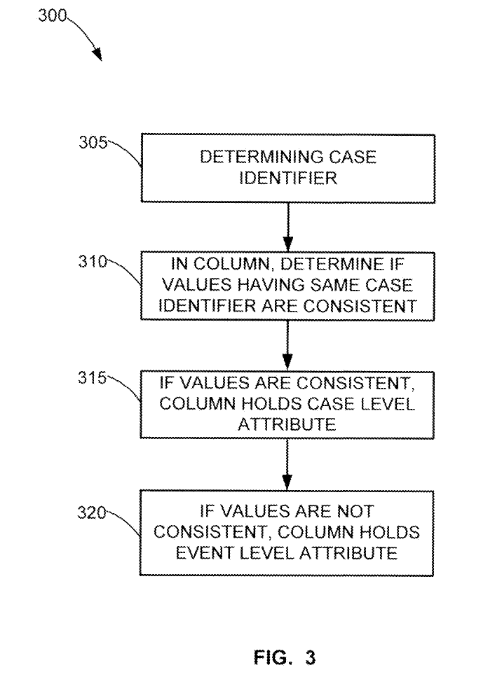

FIG. 3 shows one example embodiment of a method 300 for automatically distinguishing case level attributes from event level attributes in example data log 100 of FIG. 1 and data log 200 of FIG. 2. At block 305, a case identifier is determined. In some aspects, determining a case identifier may include receiving an input from a user specifying the case identifier in a data log. For example, a user interface, such as a device monitor or display screen, may prompt a user to specify the column containing the case identifier from among other columns from a given raw set of data using an input device, such as a mouse or keyboard. In some aspects, the user interface may function as both a display screen and input device, such as a touch screen display. Referring to FIGS. 1 and 2, a user may specify that column Case ID 105 and column Case ID 205 in data logs 100 and 200, respectively, contain the case identifiers for data logs 100 and 200, respectively.

In other aspects, the first or other column of a data log may be preset as the default column for the case identifier.

At block 310, each of the other columns in data logs 100 or 200 are automatically, without user intervention, checked or compared to determine if all of the values in columns that share the same case identifier are consistent or contain identical data. For example, in data log 100, case identifiers in column Case ID 105 have been sorted to illustrate the events having the same case identifiers, shown as cases or groups 140, 145, 150 and 155 in FIG. 1. In each of these groups 140, 145, 150 and 155 of events, each group has the same case identifier, and the values of the other columns may then be checked or compared for consistency.

In another example, using data log 200 of FIG. 2, case identifiers in column Case ID 205 have been sorted to illustrate the cases or the events having the same case identifiers together, shown as cases or groups 235, 240 and 245. In each of these cases or groups of events, each group has the same case identifier, and the values of the columns are checked for consistency.

It will be appreciated that in some aspects, no pre-sorting of the case identifiers is needed in order to determine consistency. In such aspects, the application performing the example automatic level detection method of FIG. 3 may read the data in each row of the data log, and if the case identifiers match, store or record the data in a temporary memory or file and determine consistency using such stored data.

It will also be appreciated that in some aspects, values in the columns may be normalized or converted to a specific format prior to determining in the values in the columns are consistent. By way of example, but not limitation, a column containing names may compare only the first and last names but not the middle initial. As another example in other aspects, values in a column containing timestamps may be checked or verified to ensure that all values the same format is and parsed if necessary prior to the comparison of values.

At block 315, if values in a column are determined to be inconsistent or not identical for a particular case identifier, the column is identified or classified as containing event level attributes. For example, the data values or rows in column Activity 110 of FIG. 1 for group 140 are checked and determined to contain inconsistent values, i.e., Register appeal. Confirm reception, Register receipt of document. Result hearing, Withdraw appeal and Archive. Because the values in column Activity 110 for case 140 are different, column Activity 110 is classified as holding or containing event level attributes.

Similarly, Activity Start Time 115 is determined to hold event level attributes because each entry in column Activity Start Time 115 corresponds to the time the event, activity, step or operation started. Other columns in data log 100 that are found to hold event level attributes include column Activity 105, column Activity Complete Time 120 and column Employee 125.

At block 320, if values in a column are determined to be consistent, the column is identified as containing case level attributes. For example, in FIG. 1 the data value in column Case Type 130 for each row associated with group 140 contains the value “Schoolbus”—a consistent value for all of the events or activities in group 140. Thus, because the values in column Case Type 130 for each case are the same, column Case Type 130 is determined to contain case level attributes.

In example data log 200, column Purchased Item 225 contains a consistent value for each group or case 235, 240, 245. Thus, Purchased Item 225 is determined to hold case level attributes—attributes that are common and global for a given case, as uniquely represented by case identifiers in column Case ID 205.

In some instances, the value of an attribute for a given row may be undefined or empty. In some such example embodiments, the undefined or empty values may be omitted and not considered by the application performing the example method of FIG. 3, and the consistency checks are performed only on the non-empty (defined) values. In other example embodiments, the empty values may be treated as values, and if a column contains identical values for given case identifier, the column would be classified as containing case level attributes, but if the column contains a mixture of empty and non-empty values, the column would be classified as containing event level attributes. It is understood by those skilled in the art that both treatments of undefined or empty values are covered by this disclosure.

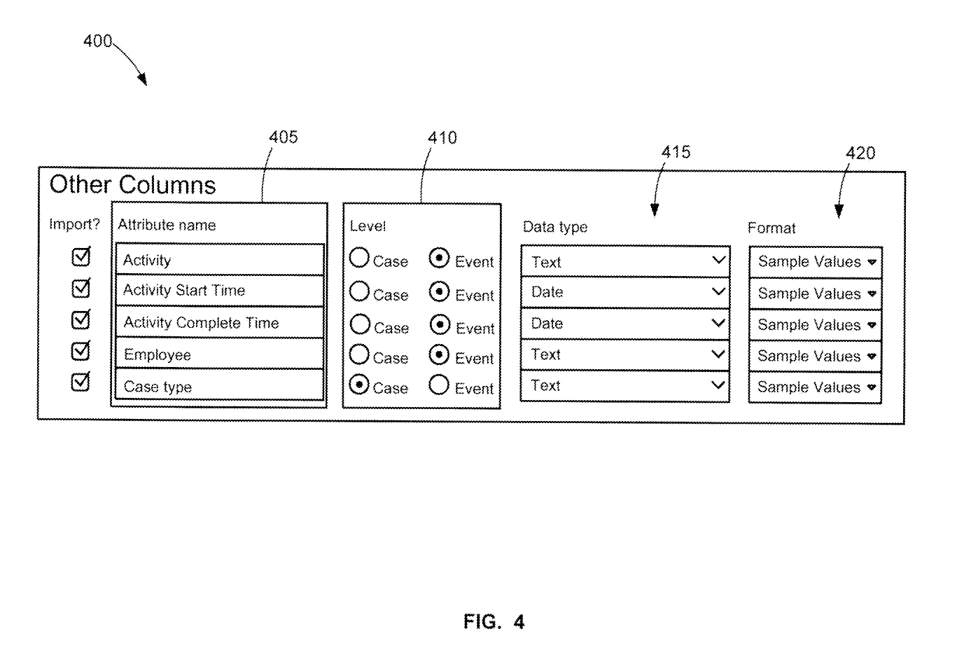

FIG. 4 is an example interface displaying information resulting from performance of the example method 300 of FIG. 3.

FIG. 4 shows an example interface 400 that displays example results from the performance of the example automatic attribute level detection method 300 using information from data log 100. In FIG. 4, column headers in data log 100 are displayed as attribute names 405. In the Level portion 410 of display 400, radial buttons are defaulted to indicate the attribute level classification, i.e., case level or event level, of each of columns 110, 115, 120, 125, 130 as detected by example method 300. Pursuant to example method 300, columns Activity 110, Activity Start Time 115, Activity Complete Time 120 and Employee 125 are set as containing event level attributes and column Case Type 130 is set as containing case level attributes. In an alternative example embodiment, a user may override the default determined level of each of the columns.

Other information associated with each of the columns may be provided, such as Data Type 415 and Format 420. Information, other than that shown in interface 400 may be provided in addition to or in lieu of the displayed information, is known in the art.

Automatic determination of event level attributes may be useful in presenting intelligent choices to a user. For example, event level attributes may be used as states in creating process models. Thus, in some example embodiments for creating a process model, only columns containing event level attributes may be presented to a user for selection.

Automatic determination of case and event level attributes may also be useful in data aggregation. When users utilize the classification of attributes in collecting and analyzing large amounts of data, miscalculations may be avoided. For example, case level attributes may be excluded from inclusion when aggregating date.

In some example aspects, if a process model involves money, and a user wants to know the amount of money associated with a particular event or activity, the amount of money may be inadvertently calculated as being a multiple of the actual value if the user or application making the calculations fails to recognize that the same data is recorded multiple times for a particular case. By identifying a column as containing a case level attributes, the values in such column can be excluded from, or included only once, in calculations for more accurate results.

As another example, if there is a desire to calculate the time associated with a particular event or activity, the amount of time may be erroneously calculated as being longer if the user or application making the calculations fails to recognize that a column that bears a time value contains case level attributes, and that the same time is the same for a particulate case.

It will be appreciated that the actions described and shown in the example flowcharts may be carried out or performed in any suitable order. It will also be appreciated that not all of the actions described in example method 300 of FIG. 3 need to be performed in accordance with the example embodiments of the disclosure and/or additional actions may be performed in accordance with other embodiments of the disclosure.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of detecting attribute levels in a dataset, comprising:
determining whether column data in a column for a case identifier is the same;
classifying the column data as case level attributes if all of the column data is identical; and
classifying the column data as event level attributes if the column data is different for at least one data entry in the column,
wherein at least one of the determining, the classifying the column data as case level attributes and the classifying the column data as event level attributes is performed by a processor.

2. The method of claim 1, further comprising repeating the determining, the classifying the column data as case level attributes, and the classifying the column data as event level attributes every unclassified column in the dataset.

3. The method of claim 1, further comprising storing the classification of the column data.

4. The method of claim 1, further comprising:
creating a process model utilizing the column data classified as event level attributes as states.

5. The method of claim 4, wherein state labels of the states correspond to column headers of the column data classified as event level attributes.

6. The method of claim 1, further comprising identifying a column associated with the column data classified as event attributes as an event column.

7. The method of claim 6, further comprising:
displaying a list of the columns identified as the event columns and receiving a user selection for an event column from which to create a process model.

8. The method of claim 7, further comprising creating a process model utilizing the event level attributes associated with the selected event column as states.

9. The method of claim 1, further comprising:
creating a social network model utilizing the column data classified as event level attributes as actors.

10. The method of claim 1, further comprising grouping rows of data sharing the same case identifier together.

11. The method of claim 1, wherein the determining whether the column data in the column is the same comprises normalizing the column data.

12. The method of claim 1, wherein column data containing undefined values is excluded from at least one of the classifying the column data as event level attributes and the classifying the column data as case level attributes.

13. A method of aggregating data in a dataset, comprising:
determining whether column data for a case identifier is the same;
classifying the column data as case level attributes if all of the column data is identical;
classifying the column data as event level attributes if the column data differs in at least one data entry in the column; and
aggregating the data in the dataset, wherein the aggregating includes each event level attribute only once,
wherein at least one of the determining, the classifying the column data as case level attributes, the classifying the column data as event level attributes and the aggregating is performed by a processor.

14. The method of claim 13, wherein the aggregated data represents money.

15. The method of claim 13, wherein the aggregated data represents time spent.

16. The method of claim 13, wherein the aggregating the data excludes case level attributes from calculations.

17. A method of classifying attribute levels in a dataset, comprising:
identifying records in the dataset having a same case identifier;
determining a classification for each attribute column of the identified records, the classification including identifying the attribute column as a case level column or an event level column, the determining including:
comparing values in the attribute column;
if values in the attribute column are the same, classifying the attributed column as a case level column; and
if at least one value in the attribute column differs from a second value in the attribute column, classifying a column as an event level column; and
displaying in a user interface, a header associated with each attribute column and the determined classification of the attribute column.

18. The method of claim 17, wherein the determined classification is modifiable by a user.

19. The method of claim 17, further comprising:
receiving a user selection for an event level column from which to create a process model.

20. The method of claim 19, wherein states in the process model are the values in the event level column.
